(19) United States
(12) Patent Application Publication
(10) Pub. No.: US 2006/0075643 A1
(43) Pub. Date: Apr. 13, 2006

(54) Coin wrapper cutter

(76) Inventor: Qamar A. Shafeek, Indianapolis, IN (US)

Correspondence Address: William M. Selenke, 5 Drummond St., Cincinnati, OH, 45218, US

(21) Appl. No.: 10/961,349

(22) Filed: Oct. 8, 2004

(51) Int. Cl. B26B 3/00

(52) U.S. Cl. 30/280

(57) ABSTRACT

The invention comprises a device to aid in the removal of the plastic or paper cover from the rolls of coins. This device is made of an elongated form with a groove on the upper surface of the elongated form. Either a cutting point or a boss will project from the base of the groove. The boss and cutting point are connected via a pivot point in the hollow of said elongated form. In the resting stage the boss is pushed into the groove by a spring. In action as that boss is pushed into the hollow by a roll of coins, the cutting point is urged via the pivot point into the groove to score the cover of the coin roll. A second embodiment of the invention is a processor to score the plastic or paper cover of rolls of coins. The processor is an elongated structure with a groove on the top side. Projecting from the base of that groove is a cutting blade which is covered by a mask. That mask covers the cutting blade because it is positioned to be superior to the cutting blade by dimples. The dimples are projections from left and right triggers. These triggers are urged to a closed position by a spring. As both the left and right triggers are outwardly expanded by a wrapped role of coins both dimples are urged away from the mask by cambers allowing mask to be depressed into the base of the groove exposing a cutting blade which will score the wrapper of the roll of coins as the roll is moved across the cutting blade.

### FIELD OF INVENTION

The invention is concerned with devices that cut or score the outer wrappings of rolls of coins. More specifically the present invention is concerned with devices that have an elongated base with ovoid or v-shaped depression with a cutting blade in the bottom. This elongated base will receive the roll of wrapped coins. The covering is scored or cut as the wrap coins are pushed over the cutting point in the bottom of the depression.

### BACKGROUND OF INVENTION

For a number of decades banks and other institutions that process large volumes of coins have wrapped them in rolls with specific numbers of coins. For example fifty pennies are packed in one roll. Forty nickels are packed in one roll. The wrappings for these coins are commonly paper, although plastic is also used. Wrapped coins are convenient to count and transport. However, they can be annoying to open. Paper wrappings may be opened with some difficulty; plastic wrapped coins are often difficult to release.

For this reason there are a number of coin wrappers removal apparatus disclosed in the patent literature. For example, Bell U.S. Pat. No. 4,001,934 disclosed a coin roll cover remover. This invention has a base and a bifurcation. At the bottom of the bifurcation is a cutting edge. The roll of coins is pushed over the cutting edge and this cutting edge scores the coin wrapper. In that invention the cutting edge is permanently affixed. Smithline U.S. Pat. No. 4,106,196, “Coin wrappers cutting device” teaches the cutting element is covered by protective members. The wrapped coins push the flexible protected members past the cutting edge which cutting edge then may scores the wrapping of coins. Schmidt and Jennings U.S. Pat. No. 6,401,339 disclosed is an apparatus for cutting a coin roll wrapper. This cover is an elongated housing. Emerging through the tube is a cutting wheel to cut the wrapper as the role of coins is pushed through. Jennings and Ganaja U.S. Pat. No. 5,964,388 teach an elongated hollow to cut the wrapped coins as the roll is pushed through the tube. Boole U.S. Pat. No. 5,992,286 describes a form with a groove with a cutting point in that groove so that the wrapper is cut as it is passed over the cutting points.

The present invention can be easily attached to a cash register, is simple to manufacture, and is relatively safe because the blade is withdrawn by a spring. It is activated only when the boss is pushed down. This invention provides a safe and quick way to score or cut a wrapped roll of coins.

### BRIEF DESCRIPTION OF FIGURES

FIG. 1 shows a perspective of the coin wrapper remover.

FIG. 2 shows the cut A-A of FIG. 1.

FIG. 3 show the coin wrapper remover in use.

FIG. 4 shows a cut A-A in perspective showing some detail.

FIG. 5 shows a detail of the mounting means of the cutting means which in this instant example is a triangular blade.

FIG. 6 show the internal spring workings of a second embodiment of the present invention.

FIG. 7 shows a section cut of the embodiment of FIG. 6.

FIG. 8 shows an alternate processor to score the plastic or paper cover of a roll of coins.

FIG. 9 show the inner workings of that alternate processor.

FIG. 10 shows left trigger and said right trigger of the alternative processor outwardly expanded.

### DETAIL DESCRIPTION OF FIGURES

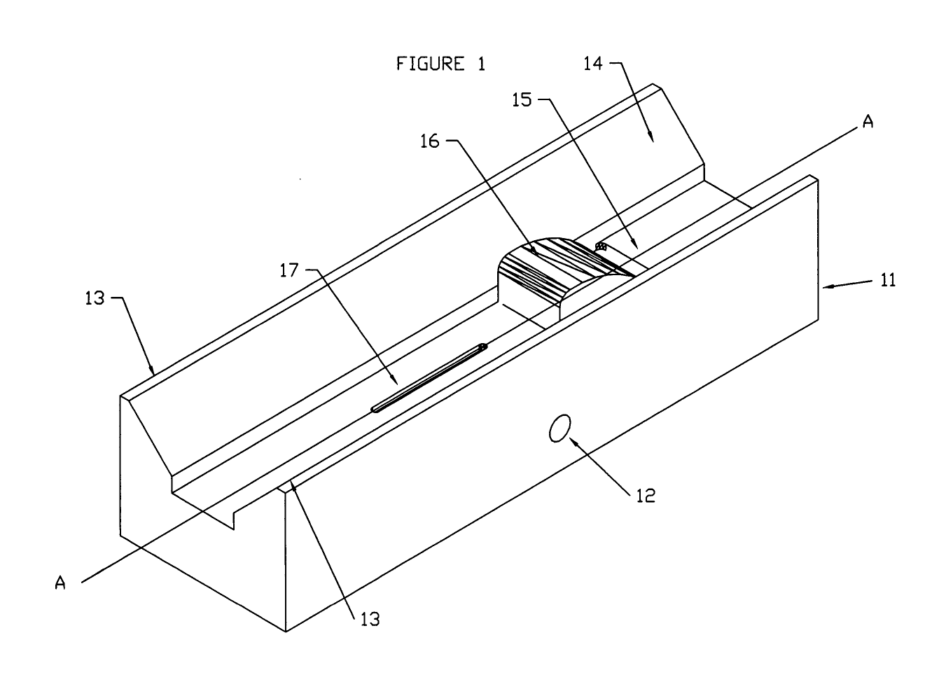

FIG. 1 shows the coin wrapper remover 11. It has an elongated form 12. On the upper surface 13 is a generally ovoid or v-shaped groove 14. At the base 15 of the groove 14 is a boss 16 which interact with slit 18 to allow cutting point 19 (not shown) to protrude. Screw holes 74 through elongated form 12 provide on attachment means to attach the wrapper remover 11 to a cash register or other money holder.

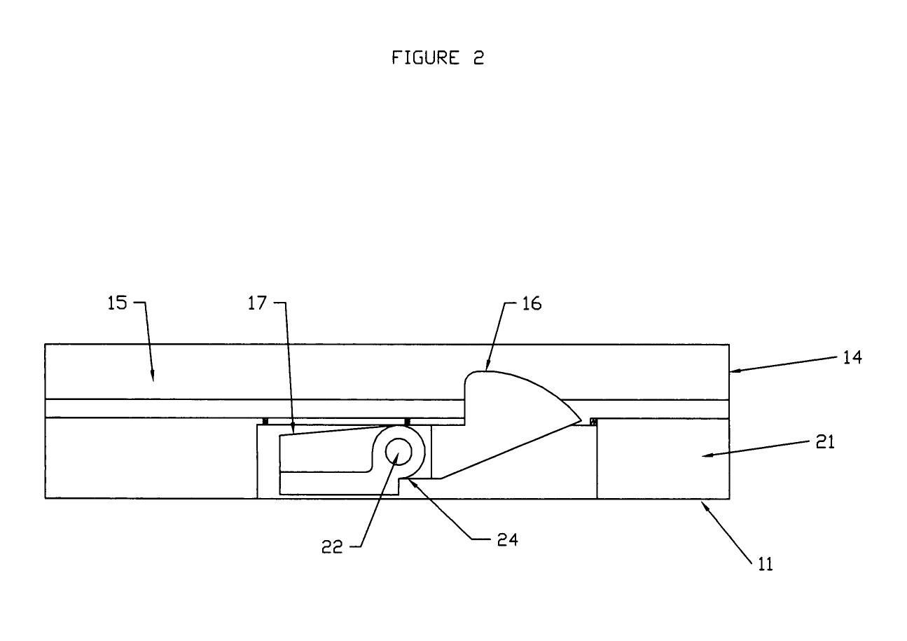

FIG. 2 show the cut A-A from FIG. 1 Boss 16 protrudes into the groove base 14. Boss 16 and cutting point retainer 17 flex on pivot point bolt 22. Pivot point bolt 22 is placed such that when boss 16 protrudes into the groove 14 the cutting point retainer 17 with attached blade 19 is recessed. Pivot point bolt 22 and associated parts are in hollow 77 of elongated form 12. However, when boss 16 is pushed into the hollow 77 by the roll of wrapped coins, the pivot pushes cutting point 19 into the groove base 15. A spiral spring 24 provides the resilience means to urge boss 16 into the groove 15 and to urge the cutting point 19 into the slit 18 of elongated form 12. A first spring extension 25 is the connecting means between boss 16 and flex point 22. Screw holes 74 through elongated form 12 provide on attachment means to attach the wrapper remover 11 to a cash register or other money holder. Pads 20 are adhesive pads to provide a second means of attaching the wrapper remover to a cash register or other money holder.

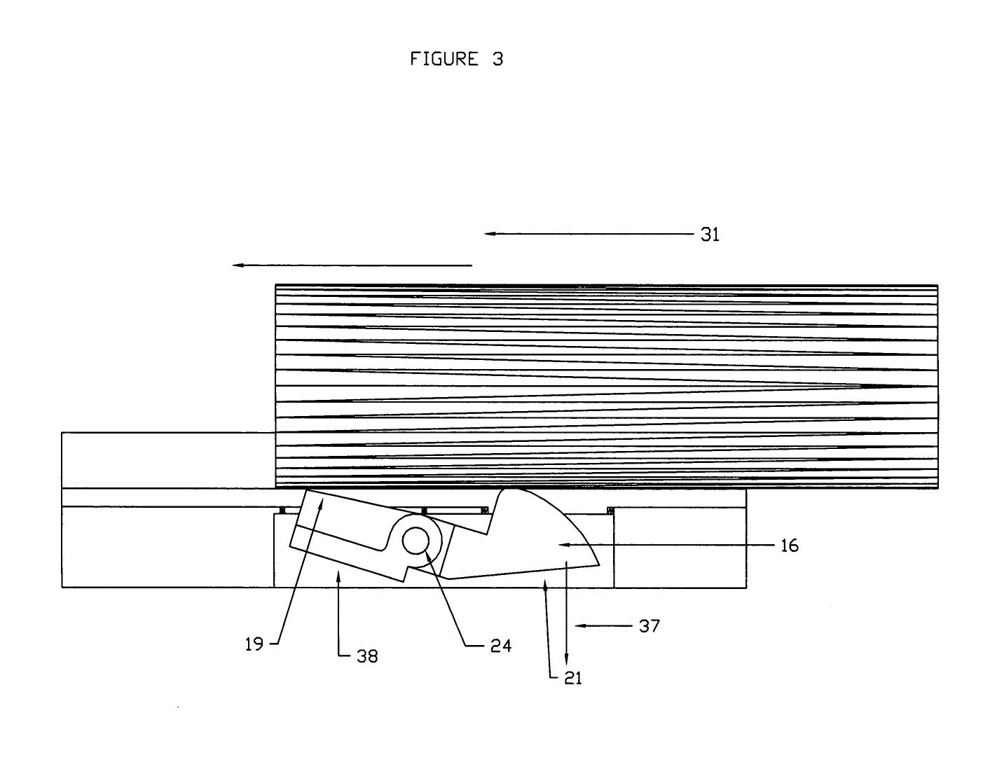

FIG. 3 shows the cut A-A of FIG. 1 with a phantom roll of coins (work piece) 31 pushed through (arrow 35 indicates movement) the groove base 14. As the roll of coins 31 is urged over boss 16 the boss 16 moves into the recess 21. Arrow 37 indicated the down ward movement of boss 16. Resilience means (spring) 24 is urged into a more compressed position and the cutting point 19 (a triangular shaped blade) is urged up (arrow 38 indicate upward movement of cutting point 19) into the groove base 15 by means of spiral spring 24. Since cutting point 19 protrudes into groove base 15, cutting point 19 will score or cut the wrapper of the roll of coins 31 as it is pushed over cutting point 19. After the cutting of the wrapper is the wrapped coins are released ready be put into cash drawer.

It is to be noted that the present invention is to be mounted on a cash register or in a cash drawer to aid removal of the cover of wrapped coins.

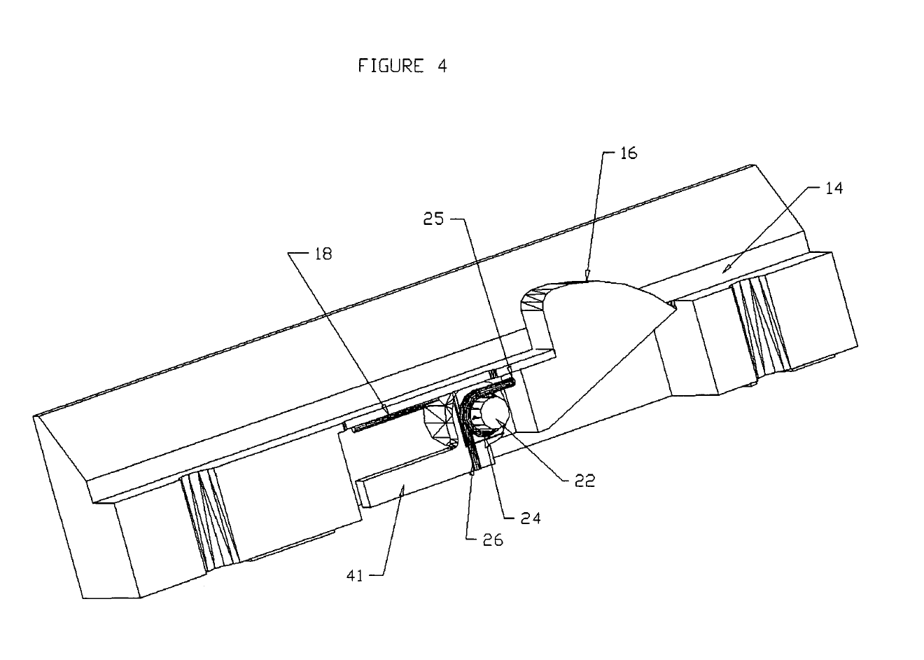

FIG. 4 shows a cut A-A in perspective showing some detail. Boss 16 protrudes into the groove base 14. Boss 16 and cutting point retainer 17 flex on pivot point bolt 22. Pivot point bolt 22 is placed such that when boss 16 protrudes into the groove 14 the cutting point retainer 17 with attached blade 19 is recessed. Spiral spring 24 provides the resilience means to urge boss 16 into the groove 15 and to urge the cutting point. 19 into the slot 18 of elongated form 12. Cutting point 19 (a triangular shaped blade) is held in place by groove holder 18. Spring extension 25 connects the pivot point 22 with the boss 16. A second spring extension 26 anchors the spring 24.

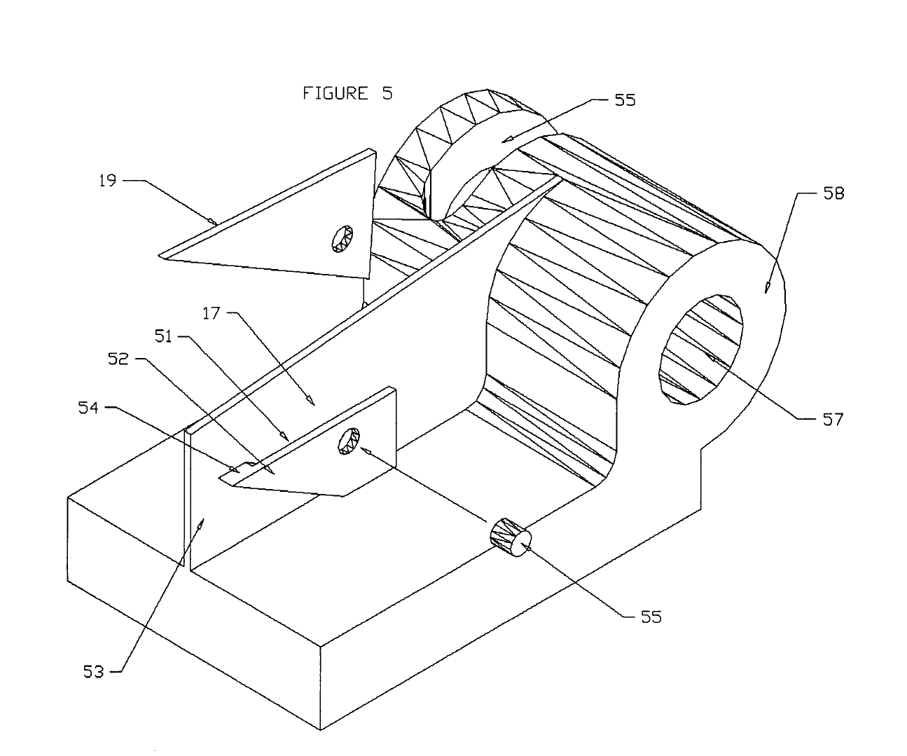

FIG. 5 shows a partial view of the internal parts of the coin wrapper remover. Cutting point retainer 17 is attached to slot 51. Slot 51 made by the partition 52 and wall 53. Spacer 54 which is part of wall 53 is the attachment means to affix wall 53 to partition 52. Cutting point 19 (a triangular shaped blade 0 is held in slot 51 by a rod 55. Rod 55 is placed through hole 57 in wall 53 and a second hole in partition 52. (Not shown is second hole in the partition 52.) Wall 53 flexes on pivot point bolt 22. Pivot point bolt 22 is placed into opening 57 such that when boss 16 protrudes into the groove 14 cutting point retainer 17 with attached blade 19 is recessed. Slice 55 in cylinder 58 is where spiral spring 24 (the means to urge boss 18 into groove 14) is placed. Pivot point bolt 22 affixes flat spiral spring 24 in place.

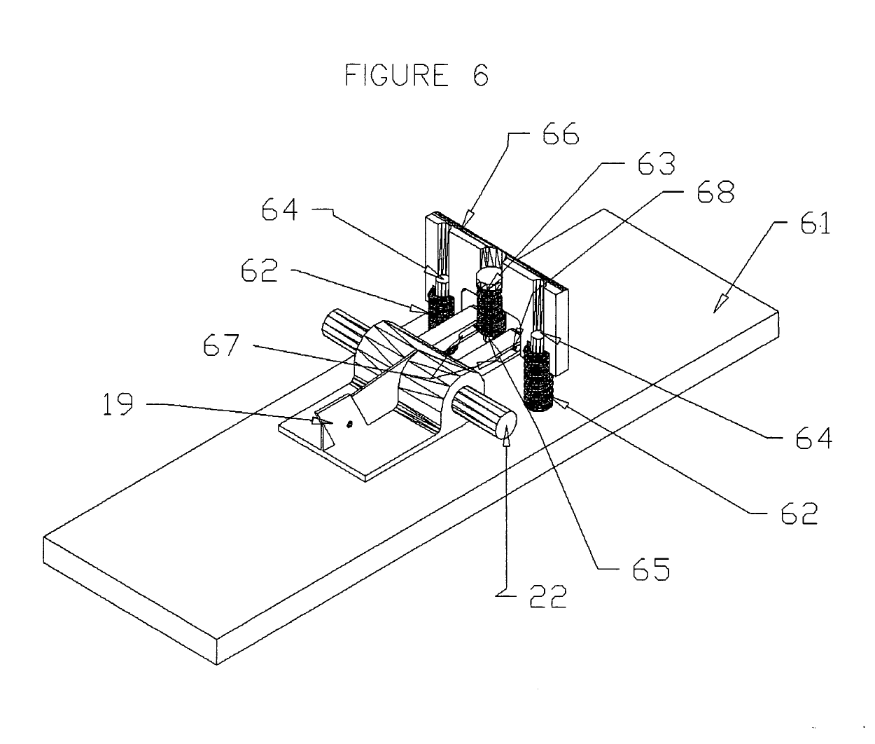

FIG. 6 shows the internal working of an alternative embodiment 61 of the present invention. FIG. 6 shows a variation on the spring means of the present invention. The movements of boss 66 are controlled first compression spring 63 and second compression springs 62. First compression spring 63 is maintained in plaice by first spring post 65. Second compression springs 62 are held in place by second compression posts 64. The purpose of second compression springs 62 is to urge boss 66 upward. First compression springs provide a resilient means so that when cutting blade 19 is urged into groove 14 and boss 66 is urged down the resilient means (first compression spring 63) allows the cutting blade 19 to float by resilient means and not be forced by rigid means. Flat holes 67 allows the peg extensions 68 free movement as boss 66 moves up and down.

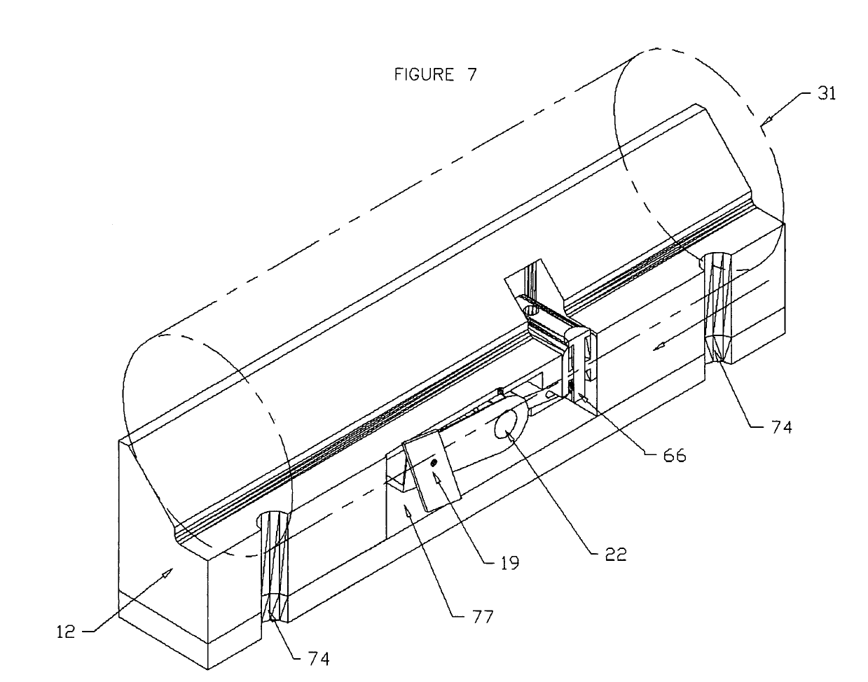

FIG. 7 shows a sagital cut of alternative embodiment 71 of the present invention. Phantom roll of coins (work piece) 31 is shown compressing boss 66. The downward force produced by the movement of boss 66 is transformed via pivot point 22 into an upward movement of cutting blade 19 which will score the covering of the wrapped coins. Pivot point bolt 22 and associated parts are in hollow 77 of elongated form 12.

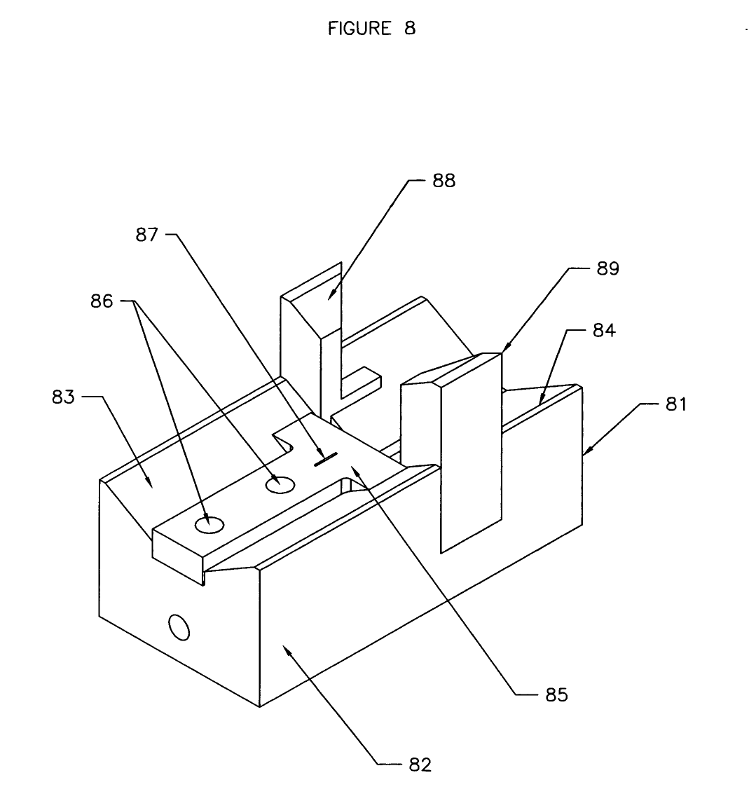

FIG. 8 shows an alternate processor 81 to score the plastic or paper cover of a roll of coins. Processor 81 is made of an elongated structure 82 with a groove 83 on the top side 84. T-shaped mask 85 is urged upward by springs (not shown). It is held in place by retainers 86. Slit 87 allows the projection of cutting blade (not shown) in the base of groove 83. Left trigger 88 and a right trigger 89 are shown.

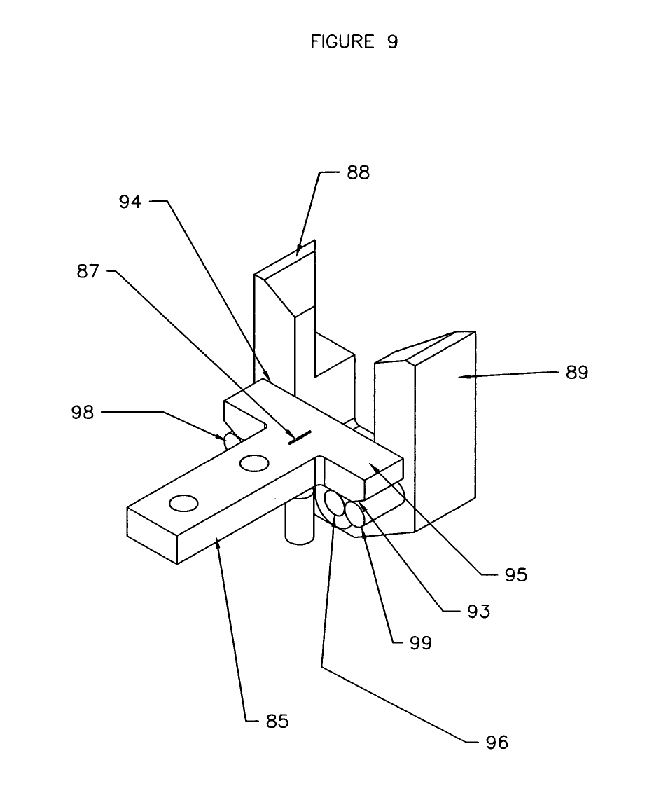

FIG. 9 show the inner workings of alternate processor 81. T-shaped mask 85 is positioned to be superior to the cutting blade by dimples 98 and 99. A spring (not shown) urges left trigger 88 and a right trigger 89 in a central direction. Dimples 98 and 99 are in projections from the left trigger 88 and said right trigger 98 and are urged to be closed by the spring which urges left trigger 88 and a right trigger 89 in a central direction. Dimples 98 and 99 react on camber 93 on the wings 94 and 95 of T-shaped mask 85 forcing mask 85 in an upward direction from groove 83 thus away form the blade which would emerge from slit 87. Axle 96 is the pivot point that holds left trigger 88 and said right trigger 98 so that they can move and allows T-shaped mask 85 to move downward and expose the cutting blade.

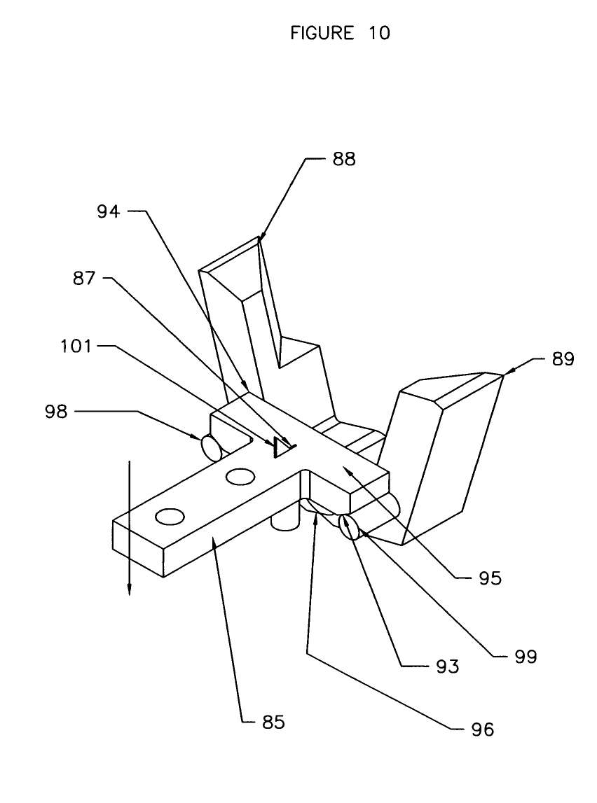

FIG. 10 shows left trigger 88 and said right trigger 89 outwardly expanded (by a wrapped role of coins). Dimples 98 and 99 react on camber 93 on the wings 94 and 95 of T-shaped mask 85 allowing blade 101 to emerge from slit 87. T- shaped mask 85 optionally does not have a spring urging it up. Gravity and the force on the roll of coins will push mask 85 down even if there is no spring under mask 85. Cutting blade 101 will score the wrapper of the roll of coins as the roll of coins is moved over cutting blade 101.

### SUMMARY OF INVENTION

The invention comprises a device to aid in the removal of the plastic or paper cover from the rolls of coins. This device is made of an elongated form with a groove on the upper surface of the elongated form. Either a cutting point or a boss will project from the base of the groove. The boss and cutting point are connected via a pivot point in the hollow of said elongated form. In the resting stage the boss is pushed into the groove by a spring. In action as that boss is pushed into the hollow by a roll of coins, the cutting point is urged via the pivot point into the groove to score the cover of the coin roll.

A second embodiment of the invention is a processor to score the plastic or paper cover of rolls of coins. The processor is an elongated structure with a groove on the top side. Projecting from the base of that groove is a cutting blade which is covered by a mask. That mask covers the cutting blade because it is positioned to be superior to the cutting blade by dimples. The dimples are projections from left and right triggers. These triggers are urged to a closed position by a spring. As both the left and right triggers are outwardly expanded by a wrapped role of coins both dimples are urged away from the mask by cambers allowing mask to be depressed into the base of the groove exposing a cutting blade which will score the wrapper of the roll of coins as the roll is moved across the cutting blade.

I claim:

1) A device to aid in the removal of the plastic or paper cover from the rolls of coins comprising:
an elongated form with an elongated groove on the upper surface of said elongated form;
projecting from the base of said groove is either a boss or a cutting point;
said boss and said cutting point are articulated via a pivot point;
said pivot point is in hollow of said elongated form;
said boss is urged into said groove by a resilience means;
wherein as said boss is pushed into said hollow by work piece said cutting point is urged into said elongated groove to score the cover of the coin roll.

2) A device to aid in the removal of the plastic or paper cover from the rolls of coins as in claim 1) wherein said resilient means is a spiral spring maintained in place by pivot point bolt and a slice in cylinder;
an extension of said spiral spring is the connecting means between said boss and said pivot point.

3) A device to aid in the removal of the plastic or paper cover from the rolls of coins as in claim 1);
wherein said resilient means is a first compression spring maintained in place by first spring post;
said first compression spring urges said cutting point into said groove;
said second compression springs are held in place by second compression posts;
whereas said second compression springs urge said boss upward into said groove.

4) A device to aid in the removal of the plastic or paper cover from the rolls of coins as in claim 1) wherein said elongated form is attached to a cash register by attachment means.

5) A device to aid in the removal of the plastic or paper cover from the rolls of coins as in claim 1) wherein said attachment means are screws.

6) A device to aid in the removal of the plastic or paper cover from the rolls of coins as in claim 1) wherein said attachment means are adhesive pads.

7) A processor to score the plastic or paper cover of rolls of coins comprising:
an elongated structure with a groove on the top side:
projecting from the base of said groove is a cutting blade;
covering said cutting blade is a mask;
said mask is urged to be superior to said cutting blade by cambers on said mask and dimples on a left and a right trigger;
said dimples are in projections from said left and said right trigger;
said left trigger and said right trigger are urged to a closed position by resilient means
when both said left and said right trigger are outwardly extended by a wrapped roll of coins both of said dimples are urged along said cambers on said mask allowing said mask to move to said base of said groove exposing said cutting blade which will score the wrapper of the roll of coins as the roll is moved across said cutting blade.
